(19) United States
(12) Patent Application Publication
(10) Pub. No.: US 2026/0320388 A1
(43) Pub. Date: Oct. 15, 2026

(54) SESSION DATA ENCODING USING ADAPTIVE BINNING AND PER-SESSION STATE TRANSITION MODELING

(71) Applicant: Rockfish Data, Inc., San Ramon, CA (US)

(72) Inventors: Xi Jiang, Chicago, IL (US); Deepanshu Bakhru, Pittsburgh, PA (US); Giulia Fanti, Pittsburgh, PA (US); Vyas Sekar, Pittsburgh, PA (US)

(21) Appl. No.: 19/642,326

(22) Filed: Apr. 8, 2026

Related U.S. Application Data
(60) Provisional application No. 63/786,138, filed on Apr. 9, 2025.

(51) Int. Cl. G06N 3/08; G06N 3/0455; G06N 3/0475

(52) U.S. Cl. CPC G06N 3/08; G06N 3/0455; G06N 3/0475

(57) ABSTRACT

A method for preprocessing session data for generative model training includes performing binning on at least one measurement field of a source dataset of the session data that includes multiple sessions by grouping unique state values of a global state space into a plurality of bins. The global state space is defined by the unique state values of the measurement field across the sessions. The method further includes performing transition analysis on the at least one measurement field independently for each of the sessions to capture intra-sessional state transition information for the measurement field. The preprocessed session data may be used to generate synthetic session data by generating an encoded synthetic dataset with the bin identifiers from a generative model trained using the encoded dataset and decoding the encoded synthetic dataset to produce the synthetic session data.

### CROSS-REFERENCE TO RELATED APPLICATIONS

This application claims priority to Provisional Application No. 63/786,138 filed on Apr. 9, 2025. The disclosure of the aforementioned application is hereby incorporated by reference in its entirety.

### TECHNICAL FIELD

The present invention relates generally to generative modeling, and, in particular embodiments, to systems and methods for encoding session data to train generative models used to generate synthetic session data.

### BACKGROUND

Enterprises and organizations across a wide range of industries collect and store data such as operational data that reflects the activities and interactions of users, customers, devices, and other entities. Operational data is commonly organized into sessions, where each session represents a grouping of records associated with a particular entity over a period of time. Each session may include metadata attributes that remain constant throughout the session, such as a user identifier or account type, and measurement fields that vary from record to record, such as a transaction amount, a visited URL, or a merchant identifier. The combination of metadata and measurement fields across many sessions forms a rich dataset that can be used for analytics, modeling, and decision-making.

Measurement fields within operational datasets can take on a wide variety of data types, including boolean, integer, floating-point, string, and categorical types. The number of unique values that a measurement field can assume, commonly referred to as the cardinality or support of the field, varies considerably depending on the nature of the data. Some fields have low cardinality (e.g., a boolean field that takes only two values). Other fields have very high cardinality, such as a field representing URLs visited by users on a website, merchant identifiers in financial transaction records, or product SKUs in an e-commerce catalog. High cardinality fields may have hundreds, thousands, or even millions of unique values across an entire dataset.

Deep generative models, including generative adversarial networks (GANs), transformer-based architectures, and variational autoencoders (VAEs), have emerged as tools for producing synthetic data. Synthetic data generation can address challenges related to data sharing restrictions, privacy and compliance requirements, data sparsity, and the cost of collecting real-world data at scale. Generative models learn statistical patterns from a training dataset and produce new records that approximate the characteristics of the original data. The quality and utility of the generated synthetic data depend on how faithfully the generative model captures the underlying distributions, correlations, and temporal patterns present in the training data.

### SUMMARY

In accordance with an embodiment of the invention, a method for preprocessing session data for generative model training includes performing binning on at least one measurement field of a source dataset of the session data by grouping unique state values of a global state space into a plurality of bins. The source dataset includes a plurality of sessions. The global state space is defined by the unique state values of the measurement field across the plurality of sessions. The method further includes performing transition analysis on the at least one measurement field independently for each of the plurality of sessions to capture intra-sessional state transition information for the measurement field.

In accordance with an embodiment of the invention, a method for generating synthetic session data using a neural network includes performing binning on at least one measurement field of a source dataset by grouping unique state values of a global state space into a plurality of bins. The source dataset includes a plurality of sessions. The global state space is defined by unique state values of the measurement field across the plurality of sessions. The method further includes performing transition analysis on the at least one measurement field independently for each of the plurality of sessions to capture intra-sessional state transition information for the measurement field, encoding the source dataset to generate an encoded dataset by replacing the unique state values of the at least one measurement field with bin identifiers corresponding to respective bins indicated by the binning, training a generative model using the encoded dataset, generating an encoded synthetic dataset using the generative model, and decoding the encoded synthetic dataset to produce the synthetic session data. The encoded synthetic dataset includes the bin identifiers for the at least one measurement field. The synthetic session data includes a synthetic global state space corresponding to the global state space.

In accordance with an embodiment of the invention, a non-transitory computer-readable medium stores instructions that, when executed by one or more processors, cause one or more processors to preprocess session data for generative model training by performing binning on at least one measurement field of a source dataset of the session data that includes a plurality of sessions by grouping unique state values of a global state space into a plurality of bins, and performing transition analysis on the at least one measurement field independently for each of the plurality of sessions to capture intra-sessional state transition information for the measurement field. The global state space is defined by unique state values of the measurement field across the plurality of sessions.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates session data examples in accordance with embodiments of the disclosure;

FIG. 2 illustrates an example synthetic data generation process that preprocesses session data for generative model training using adaptive binning and per-session state transition modeling in accordance with embodiments of the disclosure;

FIG. 3 illustrates an example encoding process in accordance with embodiments of the disclosure;

FIG. 4 illustrates an example adaptive binning process in accordance with embodiments of the disclosure;

FIG. 5 illustrates an example transition analysis process in accordance with embodiments of the disclosure;

FIG. 6 illustrates an example method for generating synthetic session data using a neural network that uses adaptive binning and transition analysis for preprocessing source session data in accordance with embodiments of the disclosure;

FIG. 7 illustrates an example synthetic data generation system in accordance with embodiments of the disclosure;

FIG. 8 illustrates another example synthetic data generation system in accordance with embodiments of the disclosure; and

FIG. 9 illustrates a visual representation of a conventional model generation system in accordance with embodiments of the disclosure.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Preparing data for input to a generative model may involve a preprocessing or encoding step in which raw field values are transformed into a numerical representation suitable for model consumption. For categorical fields, a standard technique involves creating a binary indicator vector for each unique value, where a single indicator is set to one for the value present in a given record and all other indicators are set to zero. This representation scales linearly with the number of unique values in the field. When a categorical field has high cardinality, the resulting encoded representation contains a large number of columns, most of which are zero for any given record.

Operational datasets that are organized into sessions may exhibit characteristics that differ from flat, unstructured datasets. Within a single session, the measurement fields evolve over time and may follow patterns that are specific to that session. For example, a particular customer in a financial dataset may transact with only a small subset of all available merchants, and the order in which those merchants are visited may follow a repeatable pattern. The local state space within a session (i.e., the set of unique values observed for a measurement field within that session), is typically much smaller than the global state space observed across all sessions in the dataset. The temporal dynamics within a session, sometimes referred to as stateful evolution, reflect how measurement values transition from one record to the next and can convey meaningful behavioral or operational information.

The distinction between global and local state spaces may be relevant to how generative models learn from data. A model that is trained on an encoding of the full global state space without regard to session boundaries may not observe or learn the localized distributional patterns and temporal transitions that characterize individual sessions. The sparsity of high cardinality fields further compounds this challenge, as any single session contributes observations to only a small fraction of the total state space. Additionally, fields with skewed value distributions (where a small number of values appear frequently and a long tail of values appear rarely) present further difficulties for model training. A model exposed to such distributions may learn to reproduce only the dominant values and fail to adequately represent the less frequent values that still carry significance.

The disclosure proposes methods and systems for encoding session data to prepare for training a generative model. The session data may be organized as a dataset that includes a plurality of sessions. Each session is associated with one or more measurement fields that vary across records within the session. Some or all of the measurement fields may have high cardinality (e.g., have a large state space, meaning that the number of unique values the measurement field can assume across all sessions in the dataset is large). Within any individual session, however, the local state space for a given measurement field is typically much smaller than the global state space, and the sequence of values within the session exhibits temporal dynamics and distributional patterns that reflect meaningful behavior or structure.

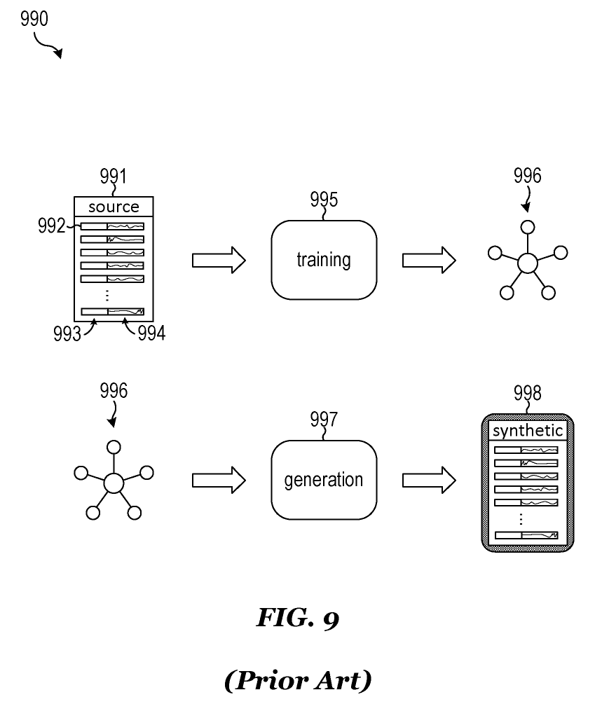

FIG. 9 illustrates a conventional synthetic data generation process 990 where a source session dataset 991 is used to train a generative model and produce synthetic session data. Specifically, source session dataset 991 includes a plurality of source sessions 992. Each source session 992 includes a tuple of attributes 993 and may include measurement fields 994. Attributes 993 may include metadata fields that are invariant within a given source session 992, such as a user identifier, an account type, or a geographic region. Measurement fields 994 may include time series data and may vary across records within a given source session 992. The measurement fields 994 can have a high cardinality state space, such as merchant identifiers in financial transaction records or URLs visited during a web browsing session.

In conventional synthetic data generation process 990, source session dataset 991 is provided as input to a training step 995. Training step 995 trains a generative model 996 based on source session dataset 991. Generative model 996 captures statistical patterns and distributions observed in source session dataset 991 and may be implemented using any of a variety of model architectures. Generative model 996 is provided as input to a generation step 997. Generation step 997 uses generative model 996 to produce synthetic session data 998, which is intended to approximate the characteristics of source session dataset 991 such that synthetic session data 998 can be used in place of or in the same way as source session dataset 991 for downstream tasks such as data sharing, compliance, or model training.

Conventional approaches to encoding categorical measurement fields for generative model training rely on one-hot encoding, which creates a binary indicator column for each unique value in the global state space. For high cardinality fields, one-hot encoding produces extremely large and sparse feature representations that consume excessive memory and increase training time. In some cases, one-hot encoding of high cardinality fields causes out-of-memory errors that prevent model training from completing. Additionally, one-hot encoding does not account for session boundaries, and as a result, the generative model does not learn the intra-sessional temporal evolution patterns or the localized distributional characteristics that distinguish one session from another. Fields with skewed value distributions further degrade model performance, as the model tends to reproduce onl9y the most frequently occurring values and fails to capture less common tail-case values.

In accordance with embodiments described herein, the disclosure addresses these limitations using a preprocessing scheme that encodes measurement fields in a manner that is aware of both the state space structure and the temporal dynamics within sessions. The preprocessing scheme has two processes that each produce an artifact. For each measurement field, an adaptive binning process is used to group the unique values in the global state space into bins. The bins may be balanced so that their aggregate representation across the dataset is proportionate relative to other bins (i.e., the “adaptive” nature of the process). The adaptive binning process keeps track of the distribution of values in each bin and stores this information in a bin artifact. Once the bins are selected, the original values in the measurement field are replaced with corresponding bin identifiers (e.g., as part of the encoding process). This reduces the dimensionality of the encoded representation while preserving the categorical nature of the data. The second process is a session-level process where the global dataset is split into sessions each session is examined independently to incrementally build a transition probability structure (e.g., a Markov chain) that captures the likelihood of transitioning from one state to another. The transition probability structure is an artifact (i.e., a transition artifact) that preserves the intra-sessional temporal dynamics observed in the original data.

The preprocessing scheme has the advantage of being model agnostic (i.e., data for any type of generation model may be preprocessed according to the disclosed scheme). That is, the encoded dataset produced by the adaptive binning process is usable in any generative model architecture for training, including GANs, transformer-based models, VAEs, and any other architecture that can use data. Because the bin identifiers represent a substantially reduced state space, one-hot encoding of the binned measurement fields produces a compact feature representation that reduces memory consumption and training time relative to one-hot encoding of the original fields (e.g., high cardinality fields).

In various embodiments, a method for preprocessing session data for generative model training includes performing binning on at least one measurement field of a source dataset of the session data by grouping unique state values of a global state space into a plurality of bins. The source dataset has a plurality of sessions and the global state space is defined by the unique state values of the measurement field across the plurality of sessions. The method also includes performing transition analysis on the at least one measurement field independently for each of the plurality of sessions to capture intra-sessional state transition information for the measurement field.

In one or more embodiments, the method further includes training a generative model using the encoded dataset, generating encoded synthetic data using the trained generative model, the encoded synthetic data including bin identifiers in place of original measurement field values, and decoding the encoded synthetic data using the bin artifact and the transition artifact to convert the bin identifiers back to the original state space. Specifically, the decoding process reconstructs realistic state transition sequences that reflect the intra-sessional temporal dynamics and distributional characteristics captured during preprocessing. These and additional details are further discussed below.

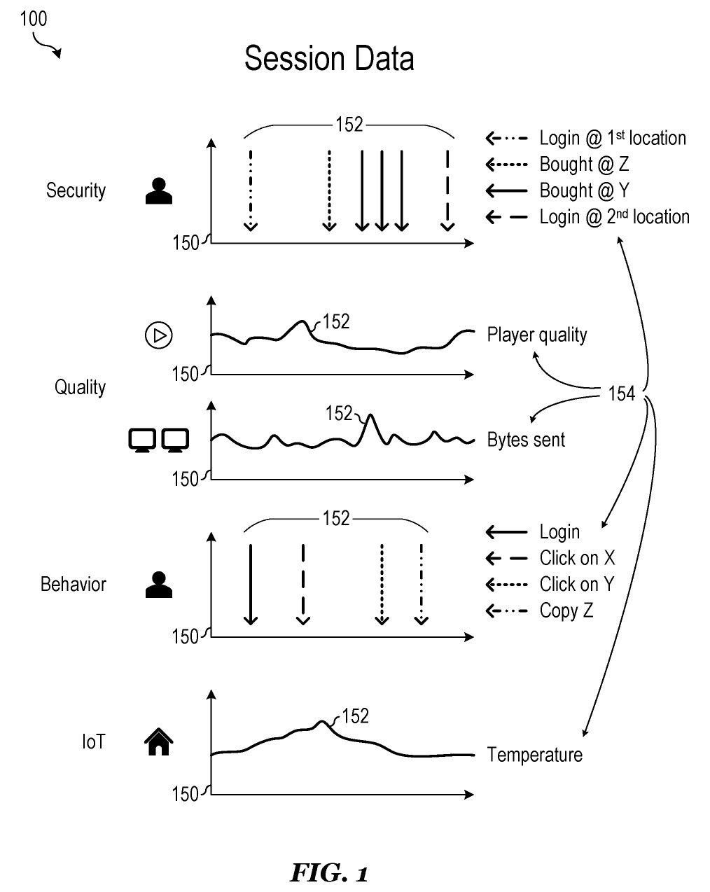

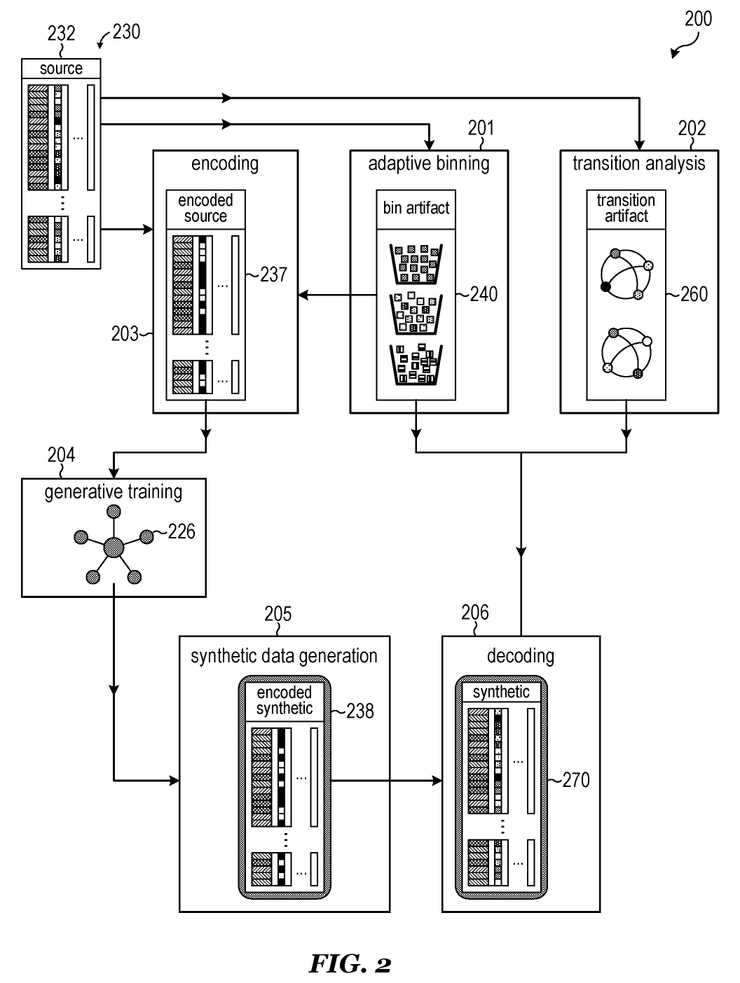

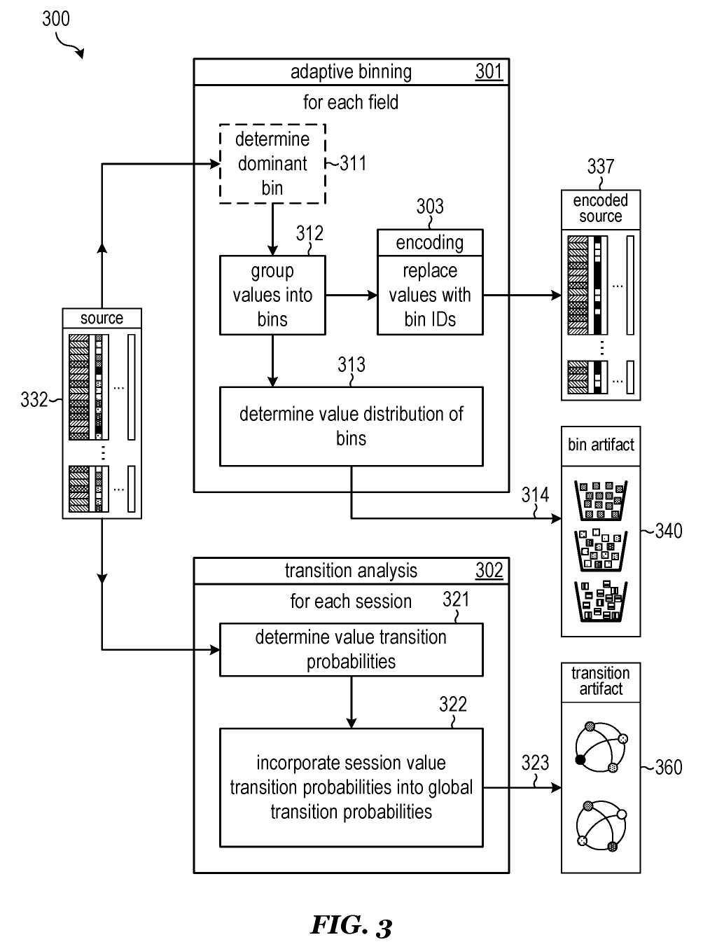

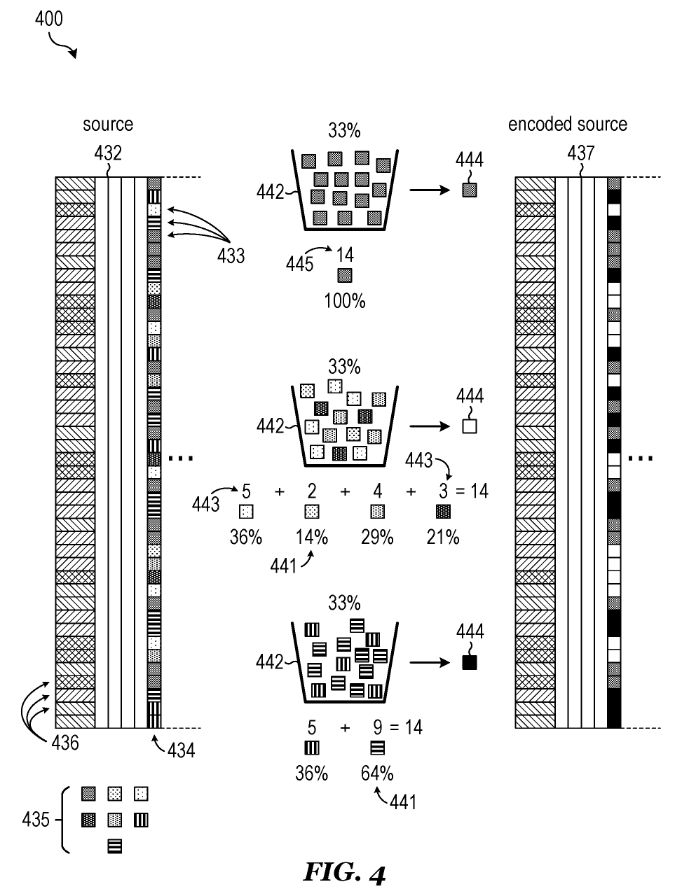

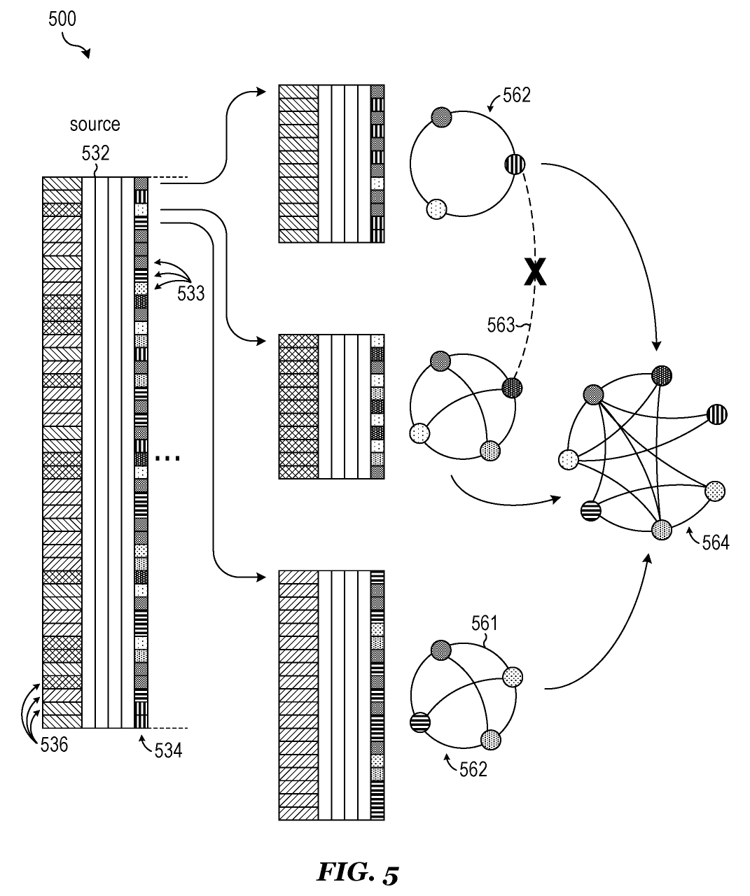

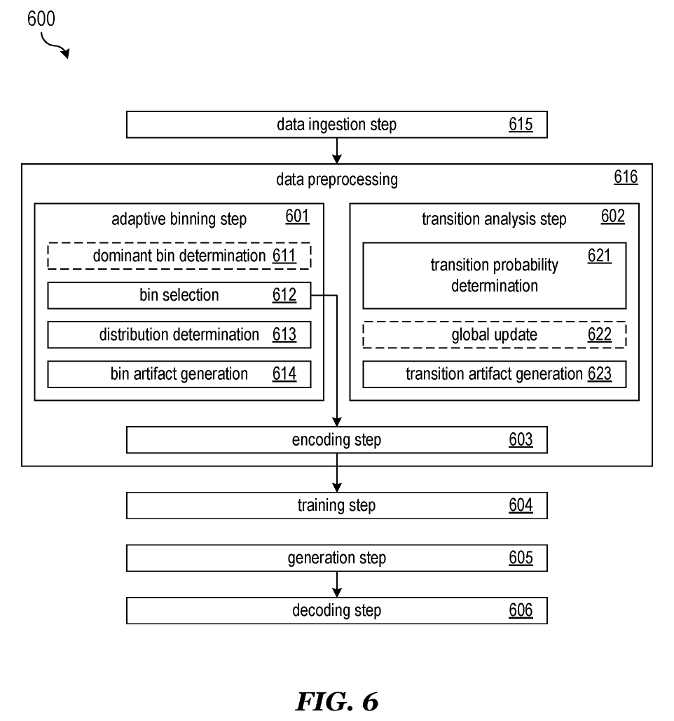

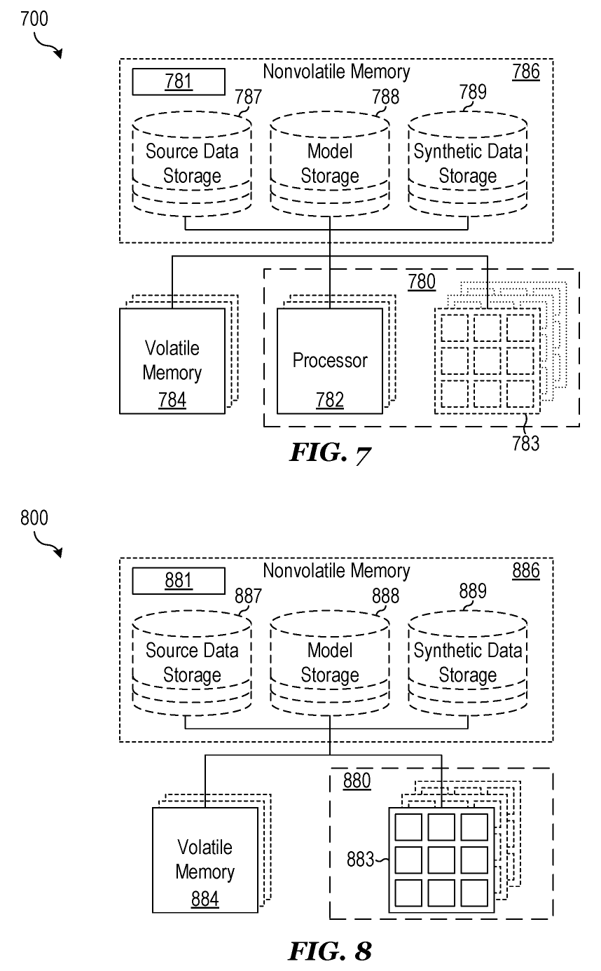

Embodiments provided below describe various methods of preprocessing session data for generative model training, and in particular embodiments, describe methods that use using adaptive binning and per-session state transition modeling to preprocess session data. The following description describes the embodiments. FIG. 1 is used to describe examples of session data that may be preprocessed using the disclosed methods. FIG. 2 is used to describe an example synthetic data generation process. FIG. 3 is used to describe an example encoding process that uses adaptive binning and transition analysis. An example adaptive binning process is described using FIG. 4 and an example transition analysis process is described using FIG. 5. An example method for generating synthetic session data is described using FIG. 6 and two examples of synthetic data generation systems are described using FIGS. 7 and 8.

FIG. 1 illustrates several examples of session data in accordance with embodiments of the disclosure. Referring to FIG. 1, session data examples 100 are shown graphically as discrete or continuous data with time as the x-axis. Each set of session data 150 includes one or more measurement fields 152. Measurement fields 152 may be events that occur at certain moments in time or may be continuously measured quantities of interest. Measurement fields 152 have values 154, which are the specific values of the measurement fields 152 that are tracked during the time interval of session data 150. Although these examples show session data associated with time (e.g., time series data), this does not have to be the case. In some embodiments, session data 150 may include one or more measurement fields 152 that have values 154 not associated with a time.

Session data 150 may include sessions that are part of a source dataset. Each of the sessions may include attributes (i.e., metadata) that are associated with different instances of session data 150 and that are invariant within a given session. In the specific example of electronic communications, the attributes may be packet information, such as packet source, destination, and ports, while values 154 (i.e., measurements) may be a sequence of packet sizes recorded at each instance in time. Another specific example is finance, where attributes may be demographic and geographic data of a bank customer and values 154 may include a sequence of actions such as deposits, withdrawals, and merchant transactions.

As shown in FIG. 1, examples of session data 150 include security data where user interactions with an electronic system (e.g., logins, buying activity), such as an online marketplace, are tracked and each user may be a session. Other types of session data 150 that may have sessions corresponding to users include connection quality data and user behavior (e.g., within a computer system). However, sessions do not have to correspond to users and may correspond to objects such as computer hardware or measurement devices (such as Internet-of-Things (IoT) devices). For example, an IoT thermostat may be a session and temperature may be tracked as values 154 in session data 150.

In various embodiments, measurement fields 152 of session data 150 may have a high cardinality state space. The state space of a measurement field 152 refers to the set of unique values that the measurement field 152 can assume. A global state space is defined by the unique values of a measurement field 152 across all sessions in the source dataset, while a local state space is defined by the unique values observed within a single session. For example, in a finance dataset, a merchant identifier measurement field may have a global state space containing hundreds or thousands of unique merchant values across all customer sessions, while any individual customer session may include only a small subset of those merchant values. The local state space within a session is typically much smaller than the global state space, and the sequence of values within a session may exhibit temporal dynamics and distributional patterns that are specific to that session. In various embodiments, the methods and processes described herein preprocess session data 150 by encoding measurement fields 152 (e.g., high cardinality fields) in a manner that reduces the global state space while preserving the intra-sessional temporal dynamics and distributional characteristics of values 154 within individual sessions.

FIG. 2 illustrates an example synthetic data generation process 200 that preprocesses session data for generative model training using adaptive binning and per-session state transition modeling in accordance with embodiments of the disclosure. Synthetic data generation process 200 receives session data 230 that includes source dataset 232 and produces synthetic session data 270 through a series of preprocessing, training, generation, and decoding steps. Source dataset 232 includes a plurality of sessions, where each session includes one or more measurement fields and may include various attributes as described above with respect to FIG. 1. One or more of the measurement fields in source dataset 232 may have a high cardinality global state space.

Synthetic data generation process 200 includes an adaptive binning step 201 and a transition analysis step 202. Adaptive binning step 201 receives source dataset 232 and groups the unique values of a measurement field in source dataset 232 into a plurality of bins. Adaptive binning step 201 generates a bin artifact 240 that maps each unique value to a respective bin and preserves frequency distribution information for each bin. Bin artifact 240 may be stored for use during subsequent encoding and decoding operations (e.g., as metadata associated with a trained generative model for example). Transition analysis step 202 receives source dataset 232 and captures intra-sessional state transition information for the measurement field. Transition analysis step 202 processes each session in source dataset 232 independently and generates a transition artifact 260 that preserves transition probability information for the measurement field. Transition artifact 260 may include a Markov chain or other transition probability structure. Adaptive binning step 201 and transition analysis step 202 may be performed in parallel, in sequence, or in any suitable order.

Synthetic data generation process 200 also includes an encoding step 203. Encoding step 203 receives source dataset 232 and uses bin artifact 240 to replace the original values of the measurement field with bin identifiers corresponding to the bins determined during adaptive binning step 201 to produce an encoded dataset 237. In various embodiments, encoding step 203 may apply one-hot encoding to the bin identifiers in encoded dataset 237. Because the bin identifiers represent a reduced state space relative to the original global state space, the one-hot encoded representation of encoded dataset 237 is more compact than a one-hot encoding of the original measurement field values.

In various embodiments, adaptive binning step 201 may be one component of a more complex encoding process performed during encoding step 203. Encoding step 203 may include other encoding operations in addition to adaptive binning, such as encodings using dictionaries, field and value manipulations, alternative representations such as vector representations, and others. Adaptive binning step 201 is shown separately in FIG. 2 for clarity, but in some implementations, adaptive binning step 201 may be integrated as part of a broader encoding pipeline that performs multiple encoding operations on source dataset 232 to produce encoded dataset 237.

Synthetic data generation process 200 includes a training step 204. Training step 204 receives encoded dataset 237 and trains a generative model 226 based on the encoded data. Generative model 226 may be any type of generative model architecture. In an embodiment, generative model 226 may be a GAN (generative adversarial network). In another embodiment, generative model 226 may be a transformer-based model. In yet another embodiment, generative model 226 may be a VAE (variational autoencoder). The preprocessing performed by adaptive binning step 201, transition analysis step 202, and encoding step 203 may have the advantage of being model agnostic allowing encoded dataset 237 to be used to train generative model 226 regardless of the specific model architecture.

Synthetic data generation process 200 includes a generation step 205. Generation step 205 uses generative model 226 to produce an encoded synthetic dataset 238. Encoded synthetic dataset 238 includes bin identifiers for the measurement field rather than original state values. Encoded synthetic dataset 238 also includes a plurality of synthetic sessions that approximate the statistical characteristics of the sessions in encoded dataset 237.

A decoding step 206 of synthetic data generation process 200 receives encoded synthetic dataset 238 and converts the bin identifiers back to original-level state values to produce synthetic session data 270 (e.g., one or more synthetic datasets with similar statistical properties as the source dataset 232). Decoding step 206 may use bin artifact 240 and transition artifact 260 to perform the conversion. In various embodiments, decoding step 206 samples from transition artifact 260 to recreate realistic transitions for the synthetic state values for each bin identifier in encoded synthetic dataset 238. The sampling may preserve the intra-sessional state transition patterns captured during transition analysis step 202, such that synthetic session data 270 exhibits realistic temporal dynamics and distributional characteristics within each synthetic session. Synthetic session data 270 includes a plurality of synthetic sessions with measurement field values that correspond to the global state space of source dataset 232.

FIG. 3 illustrates an example encoding process 300 in accordance with embodiments of the disclosure. The encoding process of FIG. 3 may be a specific implementation of preprocessing steps described in FIG. 2, including the adaptive binning step, transition analysis step, and encoding step, for example. Similarly labeled elements may be as previously described. Specifically, encoding process 300 provides additional detail regarding the preprocessing of a source dataset as described above with respect to synthetic data generation process 200 of FIG. 2.

Encoding process 300 receives a source dataset 332 and produces an encoded dataset 337, a bin artifact 340, and a transition artifact 360. Encoding process 300 includes an adaptive binning step 301 and a transition analysis step 302. Source dataset 332 is provided to both adaptive binning step 301 and transition analysis step 302. Encoding process 300 also includes an encoding step 303. As shown in FIG. 3, encoding step 303 is conceptually included within adaptive binning step 301 because encoding step 303 generates encoded dataset 337 as a result of the binning performed during adaptive binning step 301. In other embodiments, encoding step 303 may be performed as a separate step after adaptive binning step 301, such as when encoding step 303 is part of a more complex encoding process.

Adaptive binning step 301 is performed for each measurement field of source dataset 332 that is subject to binning. In various embodiments, measurement fields having a high cardinality global state space may be selected for adaptive binning step 301, while attribute fields that are invariant at a session level may be excluded. In some cases, lower cardinality measurement fields may also be excluded from adaptive binning depending on the specific details of a given application. Adaptive binning step 301 include bin selection 312, distribution determination 313, and bin artifact generation 314. In embodiments where a dominant bin is used, adaptive binning step also includes dominant bin determination 311.

Dominant bin determination 311 identifies a dominant bin from among the unique state values of a measurement field in source dataset 332. In an embodiment, the dominant bin may include a single unique state value having a highest frequency representation across source dataset 332. In another embodiment, the dominant bin may include more than one unique state value. The dominant bin may be used to establish a reference against which remaining bins may be balanced.

Bin selection 312 groups the remaining unique state values of the measurement field into bins. In various embodiments, bin selection 312 groups the unique state values such that each bin has an aggregate frequency representation that is substantially balanced relative to the dominant bin identified during dominant bin determination 311. The number of bins produced by bin selection 312 is fewer than the number of unique state values in the global state space (e.g., a much lower number bins than the global state space), and so the cardinality of the measurement field is reduced by the adaptive binning.

Distribution determination 313 determines the value distribution of each bin produced during bin selection 312. Distribution determination 313 computes the frequency distribution of the unique state values within each bin relative to the source dataset 332. The distribution information captures which unique state values belong to each bin and the relative frequency of each unique state value within its respective bin.

Bin artifact generation 314 generates bin artifact 340 based on the information produced during dominant bin determination 311, bin selection 312, and distribution determination 313. Bin artifact 340 includes distribution information. For example, bin artifact 340 may store the mapping of unique state values to their respective bins and the frequency distribution information for each bin. Bin artifact 340 may also be used during encoding step 303 and during a subsequent decoding step as described above with respect to FIG. 2.

Encoding step 303 replaces the unique state values of the measurement field in source dataset 332 with bin identifiers corresponding to the respective bins indicated by bin artifact 340. Each bin identifier is a label that represents one of the bins produced during bin selection 312. Because the number of bin identifiers is fewer than the number of unique state values in the global state space, encoded dataset 337 has a reduced cardinality for the measurement field relative to source dataset 332. In various embodiments, one-hot encoding may be applied to the bin identifiers in encoded dataset 337 prior to training a generative model. The one-hot encoded representation of the bin identifiers produces a sparse matrix that is substantially more compact than a one-hot encoding of the original unique state values.

Transition analysis step 302 is performed at a session level. Source dataset 332 is split into its constituent sessions, and transition analysis step 302 processes each session independently. Transition analysis step 302 includes transition probability determination 321, global update 322, and transition artifact generation 323.

Transition probability determination 321 determines state transition probabilities for a measurement field within a given session. For each session, transition probability determination 321 examines the sequence of values in the measurement field and computes the probability of transitioning from one state value to another within that session. Transitions between states in different sessions may be excluded, such as when domain knowledge indicates that measurement fields are independent between sessions.

Global update 322 incorporates the session-level transition probabilities determined during transition probability determination 321 into a global transition probability structure. In various embodiments, the global transition probability structure may be a Markov chain (e.g., a single global Markov chain). A Markov chain is a memory-less state transition probability matrix that captures the probability of transitioning from a current state to a next state without regard to the trajectory by which the current state was reached. Global update 322 may incrementally construct a single global Markov chain for each measurement field by incorporating the transition probabilities from each session. The global Markov chain captures the aggregate intra-sessional transition patterns observed across all sessions in source dataset 332.

Transition artifact generation 323 generates transition artifact 360 based on the global transition probability structure produced during global update 322. Transition artifact 360 stores the transition probability information for the measurement field and may be used during a subsequent decoding step as described above with respect to FIG. 2 to convert bin identifiers in synthetically generated data back to original-level state values while preserving realistic intra-sessional state transition patterns.

FIG. 4 illustrates an example adaptive binning process 400 in accordance with embodiments of the disclosure. The adaptive binning process of FIG. 4 may be a specific implementation of the adaptive binning step described in FIG. 3, for example. Similarly labeled elements may be as previously described. In particular, adaptive binning process 400 provides a specific example of adaptive binning described above with respect to FIGS. 2 and 3.

As shown in FIG. 4, adaptive binning process 400 receives a source dataset 432 and produces an encoded dataset 437. Source dataset 432 includes a plurality of sessions 436, which are shown as rectangles having different shading patterns. In this example, source dataset 432 includes three sessions. Source dataset 432 includes a measurement field 434 having a plurality of state values 433, shown as shaded squares. Measurement field 434 has a set of unique values 435. In this example, measurement field 434 has seven unique values 435, which are represented by seven distinct shading patterns. Although each of the sessions 436 may include multiple measurement fields, FIG. 4 illustrates adaptive binning process 400 with respect to a single measurement field 434 for clarity.

State values 433 of measurement field 434 are distributed across sessions 436 in source dataset 432. In this example, there are a total of 42 state values 433 across source dataset 432. The seven unique values 435 each appear one or more times among the 42 state values 433, and together they define the global state space for measurement field 434.

Adaptive binning process 400 groups unique values 435 into a plurality of bins 442. In this example, adaptive binning process 400 produces three bins using a dominant bin approach. In this example, the top bin is the dominant bin and has a highest aggregate frequency representation 445. In particular, one of the unique values 435 is represented 14 times out of the 42 state values 433. Binning all of this unique state value into the dominant bin corresponds to approximately 33% of the total representation. In this example, the dominant bin includes only one of unique values 435, which is the unique value having the highest frequency of occurrence across source dataset 432. However, in other embodiments, any number of unique state values may be included in the dominant bin, though lower numbers of unique state values in the dominant bin may be more common.

The remaining unique values 435 are grouped into the remaining bins 442 such that each remaining bin has an aggregate frequency representation 443 that is substantially balanced relative to highest aggregate frequency representation 445 of the dominant bin. A second bin of bins 442 includes four of the unique values 435 that together have an aggregate frequency representation 443 of approximately 33%, corresponding again to 14 of the 42 state values 433. As shown, the four unique values 435 in the second bin have individual counts of five, two, four, and three, which sum to fourteen. A third bin of bins 442 includes only two of the unique values 435 that together have an aggregate frequency representation 443 of approximately thirty-three percent, also corresponding to 14 of the 42 state values 433. The two unique values 435 in the third bin have individual counts of five and nine.

Each of bins 442 has a frequency distribution 441. Frequency distribution 441 represents the relative frequency of each unique value within a given bin. For the second bin, frequency distribution 441 indicates that the four unique values 435 represent approximately 36%, 14%, 29%, and 21% of the state values 433 within that bin, respectively. Similarly, for the third bin, frequency distribution 441 indicates that the two unique values 435 represent approximately 36% and 64% of the state values 433 within that bin, respectively. Frequency distribution 441 captures the distribution of unique values 435 within each bin so that the original distribution of the global state space can be reconstructed from a bin artifact during a subsequent decoding step.

In various embodiments, the bin artifact may store the frequency distribution 441 for each of bins 442 in any suitable manner. In one embodiment, frequency distribution 441 of each of bins 442 may be stored directly in the bin artifact. In another embodiment, frequency distribution 441 of each of bins 442 may be determined indirectly. For example, since each of unique values 435 is assigned to a respective bin of bins 442, knowledge of the frequency distribution of the entire global state space combined with knowledge of the bin size may be sufficient to determine frequency distribution 441 within each individual bin.

Each of bins 442 is assigned a bin identifier 444. Bin identifier 444 is a label that replaces the corresponding unique values 435 in encoded dataset 437. In this example, the dominant bin receives a bin identifier 444 shown with the same shading as the original unique value, the second bin receives a bin identifier 444 shown as a white square, and the third bin receives a bin identifier 444 shown as a black square. Even though the dominant bin is shown with the same shading as the original unique value, in practice the dominant bin may still receive a distinct bin identifier 444 because the representation of bin identifier 444 may be smaller than the representation of the actual state value.

Encoded dataset 437 is produced by replacing each of state values 433 of measurement field 434 in source dataset 432 with the corresponding bin identifier 444. As shown in FIG. 4, encoded dataset 437 includes the same sessions 436 as source dataset 432, but the cardinality of measurement field 434 in encoded dataset 437 is reduced from seven unique values 435 to three bin identifiers 444. In various embodiments, adaptive binning process 400 may be applied to measurement fields having a cardinality of greater than about 100, in which case the reduction in cardinality may be substantially larger. In such cases, each of bins 442 may include many more of unique values 435, and the bin artifact preserves frequency distribution 441 so that the original distribution of the global state space can be maintained while the cardinality of the encoded measurement field is reduced.

FIG. 5 illustrates an example transition analysis process 500 in accordance with embodiments of the disclosure. The transition analysis process of FIG. 5 may be a specific implementation of the transition analysis step described in FIG. 3, for example. Similarly labeled elements may be as previously described. In particular, transition analysis process 500 provides a specific example of the transition analysis described above with respect to FIGS. 2 and 3.

Transition analysis process 500 receives a source dataset 532. Source dataset 532 is similar to source dataset 432 described above with respect to FIG. 4. Source dataset 532 includes a plurality of sessions 536 shown as rectangles having different shading patterns. In this example, source dataset 532 includes three sessions 536. Source dataset 532 includes a measurement field 534 having a plurality of state values 533. Measurement field 534 has seven unique state values across source dataset 532.

Transition analysis process 500 begins by parsing source dataset 532 into its constituent sessions 536. The records pertaining to each of sessions 536 are grouped together while maintaining the original order from source dataset 532. As shown in FIG. 5, source dataset 532 is parsed into a first session, a second session, and a third session.

Transition analysis process 500 considers each of the sessions 536 independently to determine intra-sessional state transition information 561. For each of the sessions 536, transition analysis process 500 examines the sequence of state values 533 of measurement field 534 and determines the probability of transitioning from one state value to another within that session. In this example, intra-sessional state transition information 561 is represented as a Markov chain 562 for each of sessions 536. Each Markov chain 562 is a memory-less state transition probability structure that captures the probability of transitioning from a current state value to a next state value without regard to prior state values in the sequence.

As shown in FIG. 5, the first session includes three unique state values among its state values 533, and so the corresponding Markov chain 562 for the first session includes transition probabilities among those three unique state values. The second session and the third session each have their own respective Markov chain 562 that captures the transition probabilities observed within that session. In this simplified example, transitions from a state value back to itself are not shown in each Markov chain 562 for readability. However, such self-transitions may exist and may be captured in each Markov chain 562.

Once intra-sessional state transition information 561 is determined for a given session, transition analysis process 500 incrementally incorporates the session-level transition probabilities into a singular transition probability structure, which her is a global Markov chain 564. Global Markov chain 564 is constructed across all of sessions 536 in source dataset 532. As shown in FIG. 5, the transition probabilities from each Markov chain 562 are incorporated into global Markov chain 564 so that the intra-sessional state transition patterns observed within individual sessions are represented in global Markov chain 564.

In contrast, inter-sessional state value transitions 563 are excluded from global Markov chain 564. Inter-sessional state value transitions 563 are transitions between a last state value of one of sessions 536 and a first state value of a subsequent one of sessions 536. As shown in FIG. 5, inter-sessional state value transitions 563 are indicated by a dashed line with an X, indicating that these transitions are not present in global Markov chain 564. Transition analysis process 500 may exclude inter-sessional state value transitions 563 because state values 533 of measurement field 534 are independent between sessions 536 (e.g., transition probabilities between sessions do not reflect meaningful temporal dynamics). By excluding inter-sessional state value transitions 563, global Markov chain 564 captures only the intra-sessional state transition patterns that are relevant to the temporal evolution within individual sessions.

In various embodiments, global Markov chain 564 may be used as the transition artifact described above with respect to FIGS. 2 and 3. Global Markov chain 564 may be used during a subsequent decoding step to convert bin identifiers in synthetically generated data back to original-level state values while preserving the intra-sessional state transition patterns captured during transition analysis process 500. In other embodiments, the transition probability structure generated during transition analysis process 500 may be a data structure other than a Markov chain.

FIG. 6 illustrates an example method 600 for generating synthetic session data using a generative model that uses adaptive binning and transition analysis for preprocessing source session data in accordance with embodiments of the disclosure. Method 600 may include the processes described herein, such as the processes of FIGS. 2–5. Method 600 may be performed by one or more processors executing instructions stored on a non-transitory computer-readable medium, such as the systems described below with respect to FIGS. 7 and 8. Similarly labeled elements may be as previously described.

Method 600 begins with a data ingestion step 615. During data ingestion step 615, a source dataset is received. The source dataset includes session data having a plurality of sessions. Each session may include a plurality of records that each include at least one measurement field. A measurement field has a plurality of unique state values across the sessions that define a global state space for the measurement field. In various embodiments, the global state space may have a cardinality of greater than about one hundred unique values for a given measurement field. The source dataset may also include one or more attribute fields that are invariant at a session level, such as a user identifier, an account type, or a geographic region.

After data ingestion step 615, method 600 proceeds to data preprocessing 616. Data preprocessing 616 includes an adaptive binning step 601 and a transition analysis step 602. As shown in FIG. 6, adaptive binning step 601 and transition analysis step 602 may be performed in parallel during data preprocessing 616. In other embodiments, adaptive binning step 601 and transition analysis step 602 may be performed sequentially or in any suitable order.

Adaptive binning step 601 performs binning on the measurement field by grouping the unique state values of the global state space into a plurality of bins. In various embodiments, attribute fields that are invariant at a session level may be excluded from adaptive binning step 601. Adaptive binning step 601 may include dominant bin determination 611, bin selection 612, distribution determination 613, and bin artifact generation 614. As shown in FIG. 6, dominant bin determination 611 is indicated with dashed lines, indicating that dominant bin determination 611 is an optional sub-step of adaptive binning step 601.

In an embodiment, dominant bin determination 611 identifies a dominant bin having the highest aggregate frequency representation among the bins. Dominant bin determination 611 may identify a single unique state value or set of unique state values that have the greatest frequency of occurrence across the source dataset and designate a bin containing that unique state value as the dominant bin. Bin selection 612 groups the remaining unique state values into remaining bins such that each remaining bin has an aggregate frequency representation that is substantially balanced relative to the dominant bin. In various embodiments, a frequency distribution of the unique state values is computed across the source dataset to inform the grouping performed during bin selection 612.

Distribution determination 613 determines the frequency distribution of unique state values within each bin. The frequency distribution information captures the relative representation of each unique state value within its respective bin. Bin artifact generation 614 generates a bin artifact that stores the mapping of unique state values to bins and the frequency distribution information determined during distribution determination 613. The bin artifact preserves information sufficient to reconstruct the original distribution of the global state space during a subsequent decoding step.

Transition analysis step 602 performs transition analysis on the measurement field independently for each session in the source dataset to capture intra-sessional state transition information. Transition analysis step 602 may include a transition probability determination 621, a global update 622, and a transition artifact generation 623. As shown in FIG. 6, global update 622 is indicate with dashed lines, indicating that this is a sub-step that may vary depending on the specific implementation of transition analysis step 602. For example, separate transition probability structures may be maintained in some embodiments.

Transition probability determination 621 determines state value transition probabilities within each individual session. For each session, transition probability determination 621 examines the sequence of state values in the measurement field and computes the probability of transitioning from one state value to another within that session. Transitions between one session and another session may be excluded during transition probability determination 621.

Global update 622 incorporates the session-level transition probabilities into a global transition probability structure. In various embodiments, the global transition probability structure may be a Markov chain. Global update 622 incrementally constructs a single global Markov chain for the measurement field by incorporating the transition probabilities from each session. Transition artifact generation 623 generates a transition artifact that stores the global transition probability structure produced during global update 622.

An encoding step 303 may also be considered part of data preprocessing 616. Encoding step 603 encodes the source dataset to generate an encoded dataset by replacing the unique state values of the measurement field with bin identifiers corresponding to the respective bins indicated by the bin artifact. The bin identifiers represent a reduced state space relative to the original global state space. In various embodiments, encoding step 603 may apply one-hot encoding to the bin identifiers. The encoding performed during encoding step 603 reduces the dimensionality of the measurement field relative to a one-hot encoding of the original unique state values, which may reduce memory consumption and training time for training a generative model using the encoded dataset. Encoding step 303 may also include other encoding processes or be performed as part of a more complex encoding scheme for the source dataset.

Method 600 then proceeds to a training step 604. Training step 604 trains a generative model using the encoded dataset produced during encoding step 603. The generative model may be any suitable type of model architecture. The preprocessing performed during data preprocessing 616 and encoding step 603 may have the advantage of being model agnostic allowing the encoded dataset may be used with any generative model architecture. During a generation step 605, the trained generative model is used to generate an encoded synthetic dataset. The encoded synthetic dataset includes bin identifiers for the measurement field rather than original state values. The encoded synthetic dataset may include a plurality of synthetic sessions that approximate the statistical characteristics of the sessions in the encoded dataset.

To produce decoded synthetic session data, a decoding step 606 decodes the encoded synthetic dataset. Decoding step 606 may use the bin artifact generated during bin artifact generation 614 and the transition artifact generated during transition artifact generation 623 to convert the bin identifiers in the encoded synthetic dataset back to original-level state values. In various embodiments, decoding step 606 samples from the transition artifact to determine specific state values for each bin identifier while preserving intra-sessional state transition patterns. The synthetic session data produced during decoding step 606 includes a plurality of synthetic sessions with measurement field values that correspond to the global state space of the original source dataset.

FIG. 7 illustrates an example synthetic data generation system in accordance with embodiments of the invention. The system of FIG. 7 may be used to perform methods and processes described herein, such as the method of FIG. 6 and the processes of FIGS. 2–5, as examples. Similarly labeled elements may be as previously described.

Referring to FIG. 7, a synthetic data generation system 700 includes memory (one or both of volatile memory 784 and nonvolatile memory 786) and one or more processors 780. The memory has at least one non-transitory computer-readable medium storing a program 781 (which here is shown in the nonvolatile memory 786, but may be stored or loaded into the volatile memory 784) including instructions that, when executed by the one or more processors 780, cause the synthetic data generation system 700 to preprocess session for generative model training. For example, the instructions may cause the synthetic data generation system 700 to generate synthetic session data using a neural network. (e.g., using one or a combination of the methods and processes described herein). The program 781 may include more than one program, some or all of which and may be considered part of a preprocessing module, training module (e.g., a generative training model) or generative module (e.g., a generative model configured to generate synthetic session data using a trained generative model).

The implementation details of hardware, software, and geographic locations for the various components of the synthetic data generation system 700 are flexible, and may be determined based on the desired functionality for a given application. For example, the program 781, source session dataset(s), generative models, associated metadata (i.e., bin artifacts, transition artifacts, and others), and synthetic session datasets (including encoded synthetic datasets) may all be stored in a single geographic location and/or nonvolatile memory on some embodiments, while in other embodiments, some or all of these structures may be stored in separate locations, whether physically or virtually separated. The nonvolatile memory 786 may include one or more of a source data storage 787, model storage 788, and synthetic data storage 789, each of which may be a separate device and/or in a separate location. For example, session datasets may be stored in database storage (separate or together) and models may be stored in a model bank in some embodiments.

Possible implementations of the nonvolatile memory 786 include all types of readable storage, such as tape-based or disk-based storage, platter drives such as hard drive disk (HDD) storage, solid state drive (SSD) storage, such as flash memory, NVMe SSDs, and others. Similarly, the volatile memory 784 may be implemented in any suitable way, such as various types of random-access memory (RAM), including static RAM (SRAM), dynamic RAM (DRAM), synchronous dynamic RAM (SDRAM), synchronous graphics RAM (SGRAM), high bandwidth memory (HBM), and others. The synthetic data generation system 700 may use hierarchical memory architecture approaches, which different types of memory dedicated to specific machine learning tasks, such as active model training operations, generation operations, and persistent storage of datasets and/or models.

Similarly, while the one or more processors 780 are required to execute the program 781, the exact implementation may depend on the specific environment for which the synthetic data generation system 700 is being designed. The one or more processors 780 may include a general purpose processor 782 (or more than one). In some cases, the general purpose processor 782 may be a multicore processor or a distributed processor (including cloud computing implementations). The general purpose processor 782 is a central processing unit (CPU) in one embodiment. In various embodiments, the general purpose processor 782 is a microprocessor, and may take other forms, such as a microcontroller.

The one or more processors 780 may also include a specialized processor 783 (or more than one), such as a processor that is has a structural advantage for efficiently performing machine learning tasks (e.g., parallel processing capability, native matrix operation capability, etc.), such as training or generation tasks. For example, the specialized processor 783 may include a parallel processor, such as a TPU which may be specialized to perform neural network computations, a GPU, and others. In some cases general purpose and specialized processors may be combined, such as in an all-purpose processing unit (APU). In some situations, the specialized processor 783 may be specially designed to perform machine learning tasks or be specially designed to perform methods and processes described herein, such as using one or more ASICs (application-specific integrated circuits), which may be hardwired or programmed, such as using a field-programmable gate array (FPGA).

Of course, any of the above options for the one or more processors 780, the volatile memory 784, and the nonvolatile memory 786 may be combined in any desired combination as may be apparent to those of skill in the art in view of this disclosure. Moreover, while a high-level system overview has been provided for the sake of simplicity, the synthetic data generation system 700 may be implemented as any suitable system, ranging from embedded systems to highly complex systems with multiple compute nodes and parallel data, training, and generation pipelines. The described system components may be implemented individually or in various combinations, with the capability to scale horizontally through the addition of computing nodes or vertically through the enhancement of individual node capabilities.

FIG. 8 illustrates another example synthetic data generation system in accordance with embodiments of the invention. The system of FIG. 8 may be used to perform methods and processes described herein, such as the method of FIG. 6 and the processes of FIGS. 2–5, as examples. The synthetic data generation system of FIG. 8 is a specific implementation of the synthetic data generation system of FIG. 7 where the processing capabilities are implemented using specialized processors. Similarly labeled elements may be as previously described.

Referring to FIG. 8, a synthetic data generation system 800 includes a nonvolatile memory 886 storing a program 881 and a volatile memory 884 configured to act as working memory of the synthetic data generation system 800. As before, the nonvolatile memory 886 may be implemented in any suitable way and may include specific virtual or physical storage for datasets and models, such as a one or more of source data storage 887, model storage 888, and synthetic data storage 889.

In this specific example, the synthetic data generation system 800 includes one or more processors 880 implemented as specialized processor 883. For example, the specialized processor 883 may include TPUs, GPUs, and/or ASICs (whether hardwired or programmable, such as FPGAs) that are specifically configured to perform the preprocessing and synthetic data generation methods and processes described herein. In some embodiments, the synthetic data generation system 800 may be configured to interface with more general purpose system comprising general-purpose processors to facilitate integration of synthetic data generation methods and processes into desired applications.

While the disclosure is described primarily in the context of preprocessing high cardinality categorical measurement fields in session data for synthetic data generation using deep generative models, it should be appreciated that the inventive aspects of this disclosure may also apply to any domain in which sequential or temporal data with high cardinality categorical fields is encoded for consumption by a machine learning model. In particular, aspects of this disclosure may similarly apply to network traffic analysis where sessions represent device communication sequences across large numbers of endpoints or protocols, healthcare data modeling where patient encounter records include high cardinality fields such as diagnosis codes or medication identifiers that evolve over the course of a treatment episode, supply chain and logistics optimization where shipment or inventory records include high cardinality fields such as warehouse locations or product identifiers that transition over time, natural language processing pipelines where tokenized text sequences drawn from large vocabularies are encoded for input to generative or predictive language models, cybersecurity and intrusion detection systems where user or device activity logs include high cardinality fields such as IP addresses or process identifiers that exhibit session-specific temporal patterns, telecommunications network management where call detail records or signaling event streams include high cardinality fields such as cell tower identifiers or service codes that vary across subscriber sessions, recommendation systems where user interaction histories include high cardinality item identifiers that follow session-specific browsing or purchasing patterns, and others.

Example embodiments of the invention are summarized here. Other embodiments can also be understood from the entirety of the specification as well as the claims filed herein.

Example 1. A method for preprocessing session data for generative model training, the method including: performing binning on at least one measurement field of a source dataset of the session data by grouping unique state values of a global state space into a plurality of bins, the source dataset including a plurality of sessions, the global state space being defined by the unique state values of the measurement field across the plurality of sessions; and performing transition analysis on the at least one measurement field independently for each of the plurality of sessions to capture intra-sessional state transition information for the measurement field.

Example 2. The method of example 1, where performing the binning includes computing a frequency distribution of state values in the at least one measurement field.

Example 3. The method of one of examples 1 and 2, where performing the binning includes grouping the unique state values such that each of the plurality of bins has an aggregate frequency representation that is substantially balanced relative to other bins of the plurality of bins.

Example 4. The method of example 3, where performing the binning includes determining a dominant bin having a highest aggregate frequency representation among the plurality of bins, and balancing the aggregate frequency representation of remaining bins of the plurality of bins relative to the aggregate frequency representation of the dominant bin.

Example 5. The method of one of examples 1 to 4, where performing the transition analysis includes constructing at least one Markov chain including transition probability information of the unique state values of the global state space.

Example 6. The method of example 5, where performing the transition analysis includes incrementally constructing a single global Markov chain from Markov chains constructed for each session.

Example 7. The method of one of examples 1 to 6, where performing the transition analysis includes excluding inter-sessional state value transitions.

Example 8. The method of one of examples 1 to 7, where a cardinality of the global state space is greater than about 100 unique values.

Example 9. The method of one of examples 1 to 8, where performing the binning includes excluding at least one attribute field of the plurality of sessions that is invariant at a session level.

Example 10. The method of one of examples 1 to 9, further including: encoding the source dataset to generate an encoded dataset by replacing the unique state values of the at least one measurement field with bin identifiers corresponding to respective bins indicated by the binning, the encoding reducing dimensionality of the measurement field relative to a one-hot encoding of the measurement field thereby reducing at least one of a memory consumption or a training time for training a generative model using the encoded dataset.

Example 11. A method for generating synthetic session data using a neural network, the method including: performing binning on at least one measurement field of a source dataset by grouping unique state values of a global state space into a plurality of bins, the source dataset including a plurality of sessions, the global state space being defined by unique state values of the measurement field across the plurality of sessions; performing transition analysis on the at least one measurement field independently for each of the plurality of sessions to capture intra-sessional state transition information for the measurement field; encoding the source dataset to generate an encoded dataset by replacing the unique state values of the at least one measurement field with bin identifiers corresponding to respective bins indicated by the binning; training a generative model using the encoded dataset; generating an encoded synthetic dataset using the generative model, the encoded synthetic dataset including the bin identifiers for the at least one measurement field; and decoding the encoded synthetic dataset to produce the synthetic session data, the synthetic session data including a synthetic global state space corresponding to the global state space.

Example 12. The method of example 11, where encoding the source dataset includes applying one-hot encoding to the bin identifiers of the at least one measurement field.

Example 13. The method of one of examples 11 and 12, where performing the binning includes generating a bin artifact preserving frequency distribution information of each of the plurality of bins, where performing the transition analysis includes generating a transition artifact preserving the intra-sessional state transition information for the measurement field, and where decoding the encoded synthetic dataset includes converting the bin identifiers in the encoded synthetic dataset to the global state space by sampling the bin artifact and the transition artifact.

Example 14. The method of one of examples 11 to 13, where performing the transition analysis includes incrementally constructing a transition artifact from transition probability information of each session while excluding inter-sessional state value transitions.

Example 15. The method of example 14, where the transition artifact includes a Markov chain.

Example 16. A non-transitory computer-readable medium storing instructions that, when executed by one or more processors, cause one or more processors to preprocess session data for generative model training by: performing binning on at least one measurement field of a source dataset of the session data by grouping unique state values of a global state space into a plurality of bins, the source dataset including a plurality of sessions, the global state space being defined by unique state values of the measurement field across the plurality of sessions; and performing transition analysis on the at least one measurement field independently for each of the plurality of sessions to capture intra-sessional state transition information for the measurement field.

Example 17. The non-transitory computer-readable medium of example 16, where the instructions further cause the one or more processors to generate synthetic session data using a neural network by: encoding the source dataset to generate an encoded dataset by replacing the unique state values of the at least one measurement field with bin identifiers corresponding to respective bins indicated by the binning; training a generative model using the encoded dataset; generating an encoded synthetic dataset using the generative model, the encoded synthetic dataset including the bin identifiers for the at least one measurement field; and decoding the encoded synthetic dataset to produce the synthetic session data, the synthetic session data including a synthetic global state space corresponding to the global state space.

Example 18. The non-transitory computer-readable medium of one of examples 16 and 17, where performing the transition analysis includes constructing a single global Markov chain including transition probability information of the unique state values of the global state space by incrementally constructing the single global Markov chain from Markov chains constructed for each session.

Example 19. The non-transitory computer-readable medium of one of examples 16 to 18, where performing the binning includes grouping the unique state values such that each of the plurality of bins has an aggregate frequency representation that is substantially balanced relative to other bins of the plurality of bins.

Example 20. The non-transitory computer-readable medium of example 19, where performing the binning includes determining a dominant bin having a highest aggregate frequency representation among the plurality of bins, and balancing the aggregate frequency representation of remaining bins of the plurality of bins relative to the aggregate frequency representation of the dominant bin.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for preprocessing session data for generative model training, the method comprising:
performing binning on at least one measurement field of a source dataset of the session data by grouping unique state values of a global state space into a plurality of bins, the source dataset comprising a plurality of sessions, the global state space being defined by the unique state values of the measurement field across the plurality of sessions; and
performing transition analysis on the at least one measurement field independently for each of the plurality of sessions to capture intra-sessional state transition information for the measurement field.

2. The method of claim 1, wherein performing the binning comprises computing a frequency distribution of state values in the at least one measurement field.

3. The method of claim 1, wherein performing the binning comprises grouping the unique state values such that each of the plurality of bins has an aggregate frequency representation that is substantially balanced relative to other bins of the plurality of bins.

4. The method of claim 3, wherein performing the binning comprises
determining a dominant bin having a highest aggregate frequency representation among the plurality of bins, and
balancing the aggregate frequency representation of remaining bins of the plurality of bins relative to the aggregate frequency representation of the dominant bin.

5. The method of claim 1, wherein performing the transition analysis comprises constructing at least one Markov chain comprising transition probability information of the unique state values of the global state space.

6. The method of claim 5, wherein performing the transition analysis comprises incrementally constructing a single global Markov chain from Markov chains constructed for each session.

7. The method of claim 1, wherein performing the transition analysis comprises excluding inter-sessional state value transitions.

8. The method of claim 1, wherein a cardinality of the global state space is greater than about 100 unique values.

9. The method of claim 1, wherein performing the binning comprises excluding at least one attribute field of the plurality of sessions that is invariant at a session level.

10. The method of claim 1, further comprising:
encoding the source dataset to generate an encoded dataset by replacing the unique state values of the at least one measurement field with bin identifiers corresponding to respective bins indicated by the binning, the encoding reducing dimensionality of the measurement field relative to a one-hot encoding of the measurement field thereby reducing at least one of a memory consumption or a training time for training a generative model using the encoded dataset.

11. A method for generating synthetic session data using a neural network, the method comprising:
performing binning on at least one measurement field of a source dataset by grouping unique state values of a global state space into a plurality of bins, the source dataset comprising a plurality of sessions, the global state space being defined by unique state values of the measurement field across the plurality of sessions;
performing transition analysis on the at least one measurement field independently for each of the plurality of sessions to capture intra-sessional state transition information for the measurement field;
encoding the source dataset to generate an encoded dataset by replacing the unique state values of the at least one measurement field with bin identifiers corresponding to respective bins indicated by the binning;
training a generative model using the encoded dataset;
generating an encoded synthetic dataset using the generative model, the encoded synthetic dataset comprising the bin identifiers for the at least one measurement field; and
decoding the encoded synthetic dataset to produce the synthetic session data, the synthetic session data comprising a synthetic global state space corresponding to the global state space.

12. The method of claim 11, wherein encoding the source dataset comprises applying one-hot encoding to the bin identifiers of the at least one measurement field.

13. The method of claim 11,
wherein performing the binning comprises generating a bin artifact preserving frequency distribution information of each of the plurality of bins,
wherein performing the transition analysis comprises generating a transition artifact preserving the intra-sessional state transition information for the measurement field, and
wherein decoding the encoded synthetic dataset comprises converting the bin identifiers in the encoded synthetic dataset to the global state space by sampling the bin artifact and the transition artifact.

14. The method of claim 11, wherein performing the transition analysis comprises incrementally constructing a transition artifact from transition probability information of each session while excluding inter-sessional state value transitions.

15. The method of claim 14, wherein the transition artifact comprises a Markov chain.

16. A non-transitory computer-readable medium storing instructions that, when executed by one or more processors, cause one or more processors to preprocess session data for generative model training by:
performing binning on at least one measurement field of a source dataset of the session data by grouping unique state values of a global state space into a plurality of bins, the source dataset comprising a plurality of sessions, the global state space being defined by unique state values of the measurement field across the plurality of sessions; and
performing transition analysis on the at least one measurement field independently for each of the plurality of sessions to capture intra-sessional state transition information for the measurement field.

17. The non-transitory computer-readable medium of claim 16, wherein the instructions further cause the one or more processors to generate synthetic session data using a neural network by:
encoding the source dataset to generate an encoded dataset by replacing the unique state values of the at least one measurement field with bin identifiers corresponding to respective bins indicated by the binning;
training a generative model using the encoded dataset;
generating an encoded synthetic dataset using the generative model, the encoded synthetic dataset comprising the bin identifiers for the at least one measurement field; and
decoding the encoded synthetic dataset to produce the synthetic session data, the synthetic session data comprising a synthetic global state space corresponding to the global state space.

18. The non-transitory computer-readable medium of claim 16, wherein performing the transition analysis comprises constructing a single global Markov chain comprising transition probability information of the unique state values of the global state space by incrementally constructing the single global Markov chain from Markov chains constructed for each session.

19. The non-transitory computer-readable medium of claim 16, wherein performing the binning comprises grouping the unique state values such that each of the plurality of bins has an aggregate frequency representation that is substantially balanced relative to other bins of the plurality of bins.

20. The non-transitory computer-readable medium of claim 19, wherein performing the binning comprises
determining a dominant bin having a highest aggregate frequency representation among the plurality of bins, and
balancing the aggregate frequency representation of remaining bins of the plurality of bins relative to the aggregate frequency representation of the dominant bin.
